(19) United States
(12) Patent Application Publication
(10) Pub. No.: US 2015/0120480 A1
(43) Pub. Date: Apr. 30, 2015

(54) METHODS, SYSTEMS, AND APPARATUS FOR LISTING ITEMS IN AN ELECTRONIC COMMERCE MARKETPLACE

(71) Applicant: Oliver Nicholas Cockcroft, Los Gatos, CA (US)

(72) Inventor: Oliver Nicholas Cockcroft, Los Gatos, CA (US)

(73) Assignee: EBAY INC., SAN JOSE, CA (US)

(21) Appl. No.: 14/068,164

(22) Filed: Oct. 31, 2013

(51) Int. Cl. G06Q 30/06

(52) U.S. Cl. CPC G06Q 30/0601
USPC 705/26.1

(57) ABSTRACT

Methods, systems, and apparatus for listing an item on an electronic commerce marketplace are described. A user termination of a following of a social interest may be detected. One or more items acquired by the user that are related to the social interest may be determined, and a list of the identified items may be generated. The user may select one or more of the items in the list that are to be listed on the electronic commerce marketplace.

### TECHNICAL FIELD

The present application relates generally to electronic commerce, and more specifically, in one example, to relisting previously acquired items in an electronic commerce marketplace.

### BACKGROUND

Consumers often shop online for a wide variety of products and services and may request information, such as pricing information, for an item. Item listings may comprise a price and, optionally, one or more specific terms for the offer. A consumer may purchase an item, or a number of items, that are related to a particular social interest (such as a topic or theme) that is of interest to the consumer. Over time, the consumer may lose interest in the social interest to which the items are related and may therefore lose interest in the items themselves.

Consumers of products and services may generally include individuals, retail consumers, distributors, small business owners, business representatives, corporate representatives, non-profit organizations, and any other consumer of a product and/or service. The providers of the products and services may offer to provide the product and/or service to the consumer. The providers may include individuals, retailers, wholesalers, distributors, manufacturers, service providers, small business owners, independent dealers, and the like.

### BRIEF DESCRIPTION OF THE DRAWINGS

Some embodiments are illustrated by way of example and not limitation in the figures of the accompanying drawings in which:

FIG. 1 is a block diagram of an example system, in accordance with an example embodiment, for listing an item on an electronic commerce marketplace;

FIG. 2 is a representation of an example transaction history for a consumer, in accordance with an example embodiment;

FIG. 3 is a representation of an example social interest identification table, in accordance with an example embodiment;

FIG. 4 is a block diagram of an example apparatus, in accordance with an example embodiment, for listing an item in an electronic commerce marketplace;

FIG. 5 is an example workflow for providing assistance in listing items on an electronic commerce marketplace, in accordance with an example embodiment

FIG. 6 is a flowchart for an example method for providing assistance in listing items on an electronic commerce marketplace, in accordance with an example embodiment;

FIG. 7 is a flowchart for an example method for determining a list of acquired items related to a social interest, in accordance with an example embodiment;

FIG. 8 is a flowchart for an example method for recommending an item listing for an electronic commerce marketplace, in accordance with an example embodiment;

FIG. 9 is a representation of an example user interface for listing an item on an electronic marketplace, in accordance with an example embodiment; and

FIG. 10 is a block diagram of a machine within which instructions may be executed for causing the machine to perform any one or more of the methodologies discussed herein.

### DETAILED DESCRIPTION

In the following detailed description of example embodiments, reference is made to specific examples by way of drawings and illustrations. These examples are described in sufficient detail to enable those skilled in the art to practice these example embodiments, and serve to illustrate how the invention may be applied to various purposes or embodiments. Other embodiments of the invention exist and are within the scope of the invention, and logical, mechanical, electrical, and other changes may be made without departing from the scope or extent of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Generally, methods, systems, and apparatus for listing items on an electronic commerce marketplace are described. In one example embodiment, a consumer may accumulate a set of items related to a social interest, such as a topic or theme, that is of interest to the consumer. For example, a consumer may follow various social interests on an electronic commerce site and may purchase items related to the social interest. In another example, a consumer may accumulate items related to a particular social interest from a variety of sources, including electronic commerce websites, auctions, stores, individuals, and the like. As used herein, a social interest may be a topic, a theme, a buyer of goods and/or services, a seller of goods and/or services, a type of collectible, a sports team, a brand, a designer, and the like. As used herein, an “item” may refer to a product, a service, a combination of product and service, and the like.

A consumer may eventually lose interest in the social interest and, as a result, may lose interest in the related acquired items. In one example embodiment, a user may be provided assistance in listing one or more of the related items for sale. In one example embodiment, a user may be offered assistance in listing one or more of the related items for sale in response to the user ending an interest in or a following of a particular social interest. For example, a user may terminate a following of a particular fashion designer. In response, the user may be offered assistance in listing for sale one or more of the fashion designs created by the cited designer and acquired by the user. As used herein, a “following” is a request to receive information related to a social interest, such as following a twitter account, following a blog, and the like.

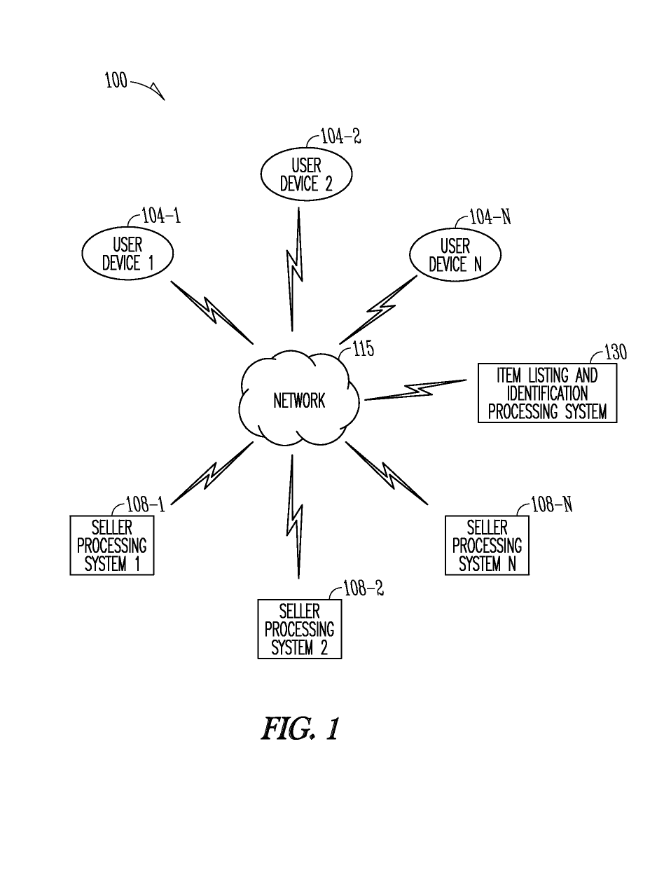

FIG. 1 is a block diagram of an example system 100, in accordance with an example embodiment, for listing an item on an electronic commerce marketplace. In one example embodiment, the system 100 may comprise one or more user devices 104-1, 104-2 and 104-N (known as user devices 104 hereinafter), one or more seller processing systems 108-1, 108-2 and 108-N (known as seller processing systems 108 hereinafter), an item listing and identification processing system 130, and a network 115. Each user device (e.g., 104-1) may be a personal computer (PC), a tablet computer, a mobile phone, a personal digital assistant (PDA), a wearable computing device (e.g., a smartwatch), or any other appropriate computer device. Each user device 104 (104-1, 104-2, or 104-N) may include a web browser program. Although a detailed description is only illustrated for user device 104-1, it is noted that each of the other user devices (e.g., user device 104-2 through user device 104-N) may have corresponding elements with the same functionality.

The seller processing systems 108 and the item listing and identification processing system 130 may be a server, client, or other processing device that includes an operating system for executing software instructions.

The network 115 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, a network of interconnected networks, or a combination of two or more such networks.

Each user device 104 may receive a query for item information from a user via an input device such as keyboard, mouse, electronic pen, and the like (not shown in FIG. 1). An item may comprise a product and/or a service, and the corresponding information may be in the form of an item listing.

An item listing and identification processing system 130 of an online listing system may store and/or obtain item listings. Each item listing may comprise a detailed description for an item. The item associated with an item listing may be a good or product (e.g., a tablet computer) or service (e.g., a round of golf or an appliance repair) that may be transacted (e.g., exchanging, sharing information about, buying, selling, making a bid on, and the like). The item listing may include a title, a category (e.g., electronics, sporting goods, books, antiques, and the like), and other tag information (e.g., color, size, and the like).

Referring back to the user device 104-1, the query received from the user of user device 104-1 may comprise one or more keywords. The user device 104-1 may submit the query to the item listing and identification processing system 130 via the network 115. The item listing and identification processing system 130 may attempt to match the query keywords with the title, the category, the tag information, and/or any other field in the item listing using a search engine.

In response to the submission of the search query, the item listing and identification processing system 130 may attempt to identify one or more item listings that satisfy the query. The item listing and identification processing system 130 may retrieve and may sort the item listings in the search result in a known manner. The item listing and identification processing system 130 may then return a sorted search result to the user device 104-1 that submitted the query.

The consumer may accept one or more offers in a known manner, or may reject all presented offers due to the price and/or terms of the offer. In one example embodiment, if the consumer purchases or otherwise acquires an item related to a particular social interest, an identification of the corresponding social interest may be maintained in the consumer's transaction history. In one example embodiment, a table may be maintained that identifies social interests that are related to each of a plurality of acquired items.

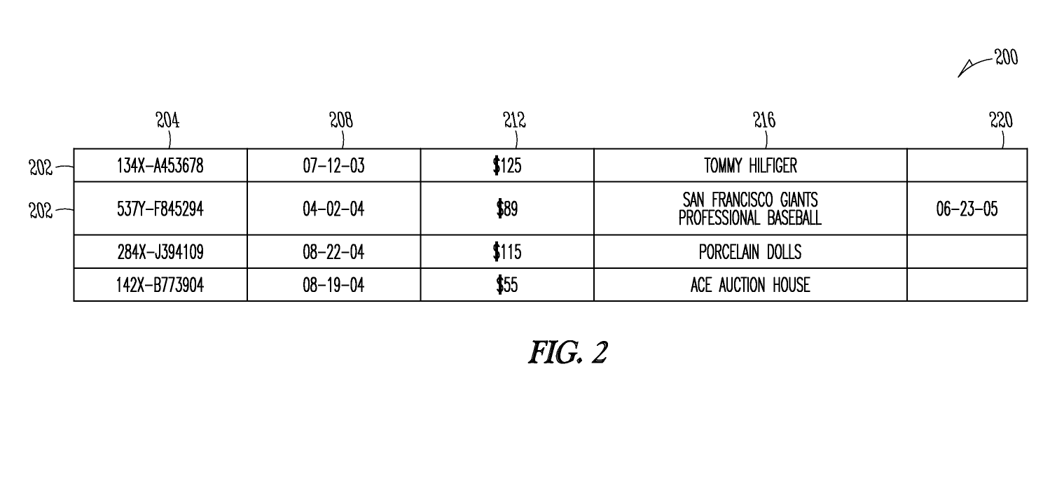

FIG. 2 is a representation of an example transaction history 200 for a consumer, in accordance with an example embodiment. Each row 202 of the transaction history 200 may correspond to an item acquired by a user. Column 204 may comprise an item identifier, column 208 may comprise a date of acquisition, column 212 may comprise a purchase price (if applicable), column 216 may comprise a name for each of one or more social interests associated with the corresponding item, and column 220 may comprise a date of disposition of the corresponding item (if applicable).

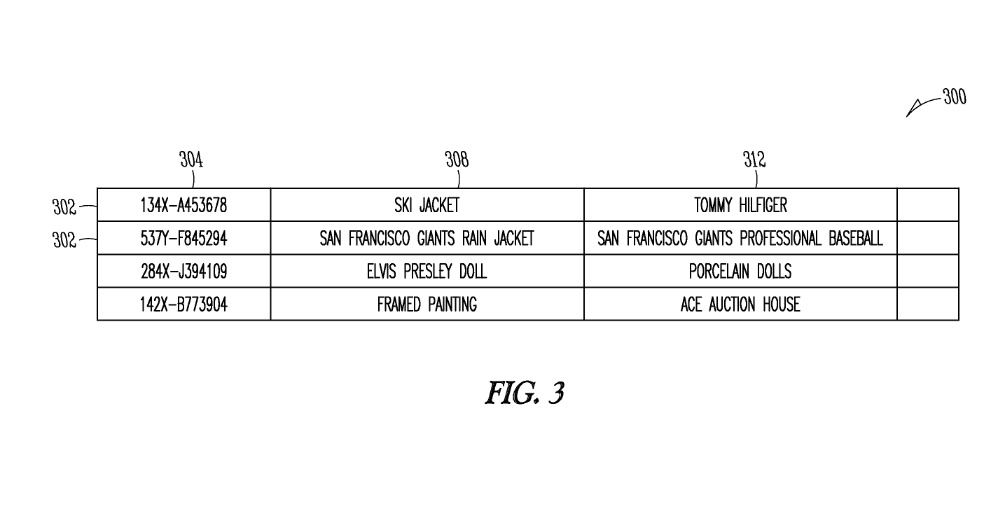

FIG. 3 is a representation of an example social interest identification table 300, in accordance with an example embodiment. The social interest identification table 300 may maintain the identification of one or more social interests that are related to a particular item. Each row 302 of the table may correspond to an item. Column 304 may comprise an identification of the item, column 308 may comprise a description of the item, and column 312 may comprise an identification of each of one or more social interests related to the corresponding item.

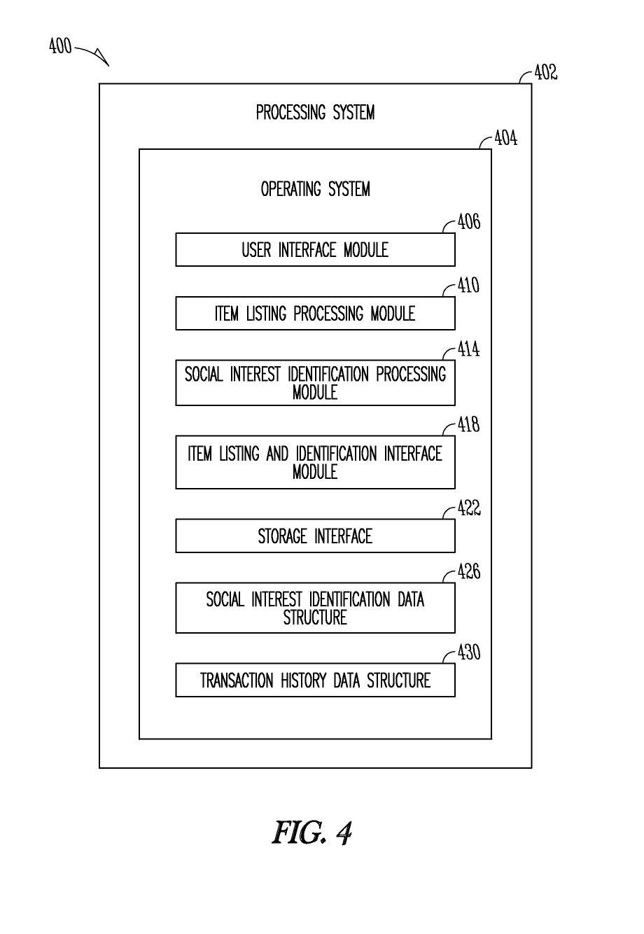

FIG. 4 is a block diagram of an example apparatus 400, in accordance with an example embodiment, for listing an item on an electronic commerce marketplace. The apparatus 400 is shown to include a processing system 402 that may be implemented on a client or other processing device that includes an operating system 404 for executing software instructions.

In accordance with an example embodiment, the apparatus 400 may include a user interface module 406, an item listing processing module 410, a social interest identification processing module 414, and an item listing and identification interface module 418. In accordance with an example embodiment, the apparatus 400 may further include a storage interface 422, a social interest identification data structure 426, and a transaction history data structure 430.

The consumer interface module 406 may provide an interface to user device 104-1 for, for example, the item listing processing module 410.

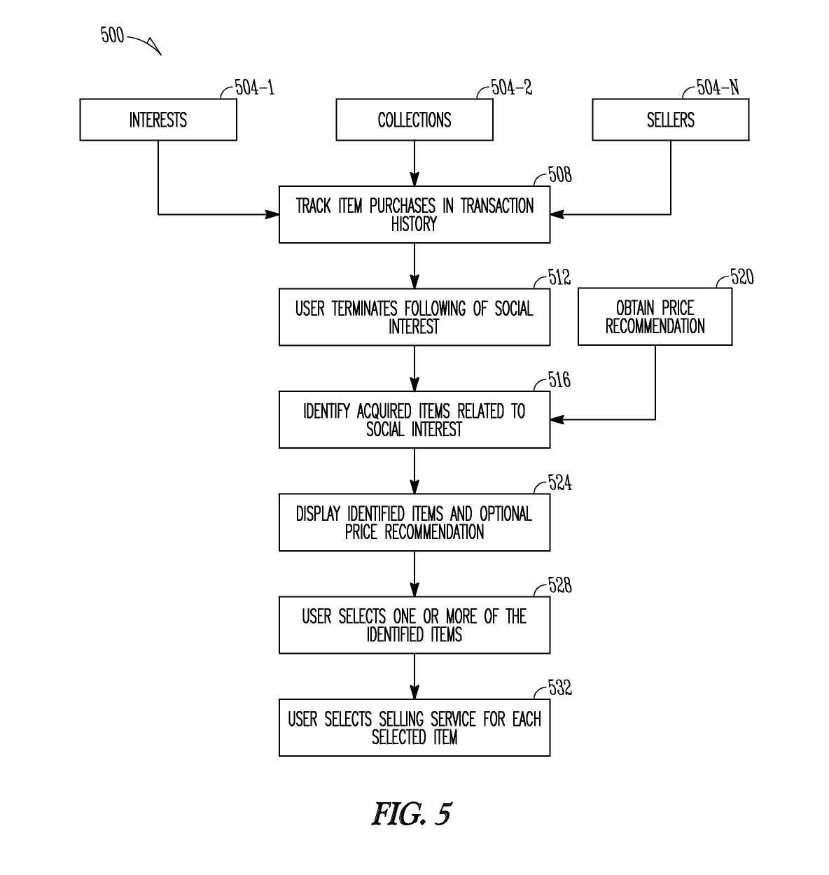

The item listing processing module 410 may provide assistance to a consumer to list items on an electronic commerce marketplace. For example, in response to a consumer terminating a following of a social interest, the item listing processing module 410 may generate a list of items related to the social interest that were acquired by the consumer and may offer assistance in listing one or more of the items for sale, as described more fully below in conjunction with FIG. 5.

The social interest identification processing module 414 may analyze one or more characteristics of an item and may determine one or more social interests to which the item is related. For example, the social interest identification processing module 414 may parse an item listing associated with the item and/or the name of an item to determine one or more social interests that the item is related to. In one example, an “Elvis Presley doll” may be determined to be related to the social interests of “Elvis Presley” and “dolls.” The social interest identification processing module 414 may obtain a social interest related to an item by accessing the social interest identification table 300, as described in conjunction with FIGS. 3 and 5.

The item listing and identification interface module 418 may interface with the item listing and identification processing system 130 and may store and/or obtain information related to items available for sale. As described above, each item listing may comprise a detailed description for the item, a picture of the item, attributes of the item, and the like. The item listing and identification interface module 418 may also obtain an item listing from the item listing and identification processing system 130 that may be recommended to a user for listing an item for sale.

The storage interface 422 may provide an interface to external storage.

The social interest identification data structure 426 may maintain the identification of social interests that are related to each of one or more items. For example, the social interest identification data structure 426 may comprise the social interest identification table 300, as described more fully above in conjunction with FIG. 3.

The transaction history data structure 430 may maintain a transaction history for each of a plurality of users. For example, the transaction history data structure 430 may comprise the transaction history 200 for each of a plurality of users, as described more fully above in conjunction with FIG. 2.

FIG. 5 is an example workflow 500 for providing assistance in listing items on an electronic commerce marketplace, in accordance with an example embodiment.

In one example embodiment, a user may follow one or more social interests 504-1 to 504-N, such as a buyer of goods and/or services, a seller of goods and/or services, a type of collectible, a sports team, a brand, a designer, and the like. The user may purchase or otherwise acquire one or more items related to one or more of the social interests. The acquisitions may be tracked and maintained in a transaction history for the corresponding user (operation 508).

At some point in time, the user may become disinterested in one or more of the social interests and may terminate a following of a particular social interest (operation 512). In response, one or more items related to the social interest may be identified (operation 516) and, optionally, a recommended price or price range for selling one or more of the items may be obtained from a pricing service (operation 520). The identified item(s) and optional price or price range may be displayed to the user (operation 524) and the user may select one or more of the identified items to be listed for sale (operation 528). In one example embodiment, the user may specify a selling service to assist in selling one or more of the items (operation 532). For example, the user may select an electronic commerce marketplace, such as the eBay Marketplace service provided by eBay of San Jose, Calif., USA, or a selling assistant, such as the eBay selling assistant service provided by eBay of San Jose, Calif., USA.

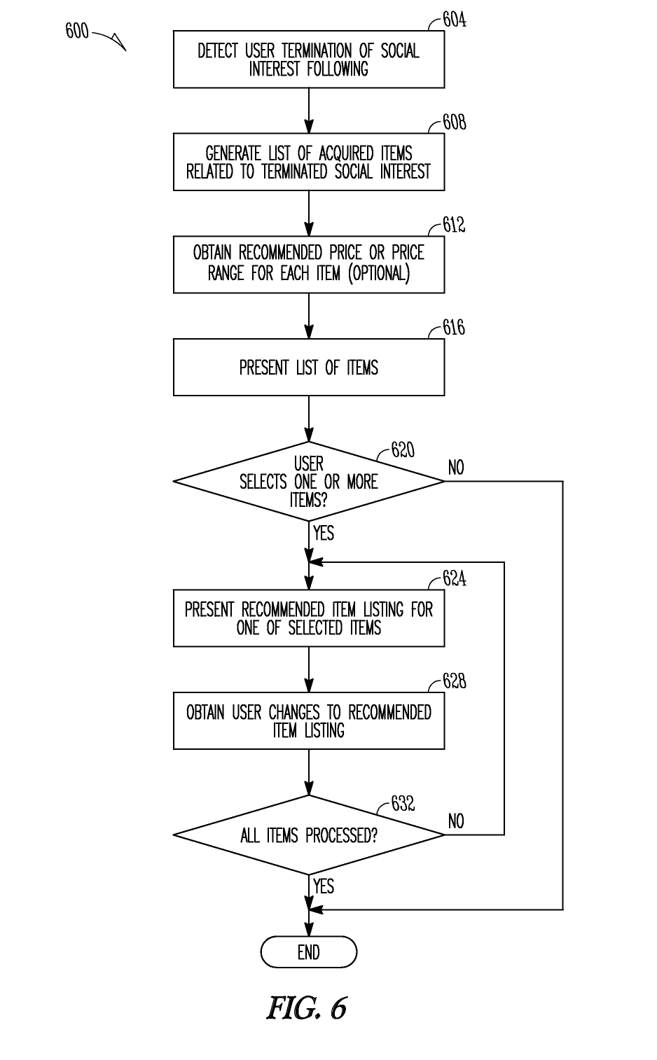

FIG. 6 is a flowchart for an example method for providing assistance for listing items on an electronic commerce marketplace, in accordance with an example embodiment. In one example embodiment, one or more of the operations of the item listing method 600 may be performed by the item listing processing module 410.

In one example embodiment, a user's termination of a following of a social interest may be detected (operation 604). For example, a user may unsubscribe to following a fashion designer. In response, the user device 104-1 may send data to the item listing processing module 410 indicating that the user has terminated a following of a social interest.

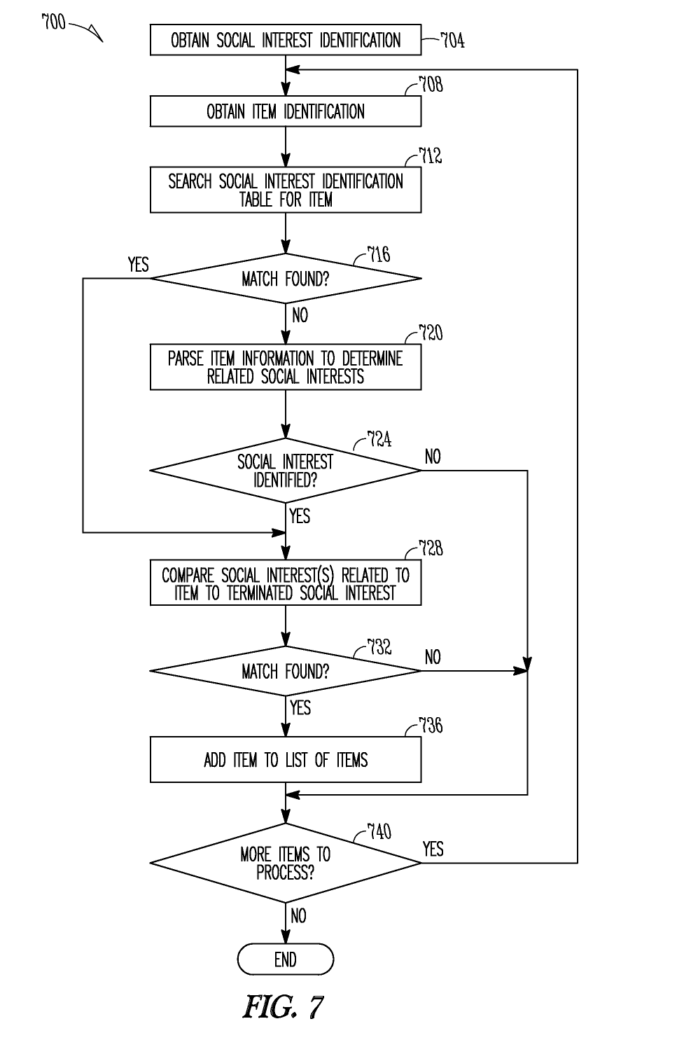

A list of one or more items that were previously acquired by the user and that are related to the unsubscribed social interest (and not known to be subsequently disposed of) may be generated (operation 608), as described more fully below in conjunction with FIG. 7. For example, the transaction history 200 corresponding to the user, which may comprise an indication of a social interest(s) related to each item, may be searched for items related to the unfollowed social interest. If a match is found, the corresponding item may be added to the list of related items. If the transaction history 200 does not comprise an indication of social interests related to each item, the item from the transaction history 200 may be looked up in the social interest identification table 300 to determine one or more social interests related to the item. The identified social interests may be compared to the social interest of the terminated following. If the social interests match, the item may be added to the list of related items.

In one example embodiment, the generated list may be augmented to include a recommended price or price range for each item. For example, the item listing and identification processing system 130 may be queried to obtain a current, recent or recommended price for the corresponding item (operation 612).

The generated list may be presented to the user with an offer to assist in listing for sale one or more of the items on the list (operation 616). A test may be performed to determine if the user has selected any items in the generated list (operation 620). If the user has not selected any items, the method may end; otherwise, for each item selected by the user, a recommended item listing may be obtained, as described more fully below, and presented to the user (operation 624). In one example embodiment, a recommended listing may include a recommended price or recommended price range.

In one example embodiment, a user may be given the opportunity to modify the item listing and the optional recommended price and the one or more changes to the item listing made by the user may be obtained (operation 628). In one example embodiment, the user may be prompted to update the condition of the item in the listing, add a recent photograph of the item, and the like.

A test may be performed to determine if all the selected items have been processed (operation 632). If all the selected items have been processed, the method may end; otherwise, the method may proceed by presenting the next recommended item listing to the user (operation 624).

FIG. 7 is a flowchart for an example method 700 for generating a list of acquired items related to a social interest, in accordance with an example embodiment. In one example embodiment, one or more of the operations of the method 700 may be performed by the social interest identification processing module 414.

An identification of a social interest, such as a social interest that a consumer has terminated a following of, may be obtained (operation 704) and an identification of an item may be obtained (operation 708). For example, the user device 104-1 may send data to the social interest identification processing module 414 indicating the social interest that user has terminated a following of and the transaction history 200 may be accessed to obtain an identification of an item.

The item may be searched for in the social interest identification data structure 426 (operation 712). A test may be performed to determine if the item was located in the social interest identification data structure 426 (operation 716). If the item was located in the social interest identification data structure 426, the method may proceed with operation 728; otherwise, information on the item, such as the item name and/or an item description, may be obtained and parsed to determine one or more social interests related to the item (operation 720). For example, the item name and/or the description of the item may be obtained from the transaction history 200 and may be parsed to determine one or more social interests related to the item. A test may be performed to determine if at least one social interest related to the item has been identified (operation 724). If no social interest has been identified, then the method may proceed with operation 740; otherwise, the method may proceed with operation 728.

During operation 728, each identified social interest is compared to the obtained social interest. A test may be performed to determine if at least one of the identified social interests matches the obtained social interest (operation 732). If at least one of the identified social interests matches the obtained social interest, the item is added to the list of acquired items (operation 736); otherwise, the method proceeds with operation 740.

During operation 740, a test may be performed to determine if there are more items to process. If there are more items to process, the method may proceed with operation 708; otherwise, the method may end.

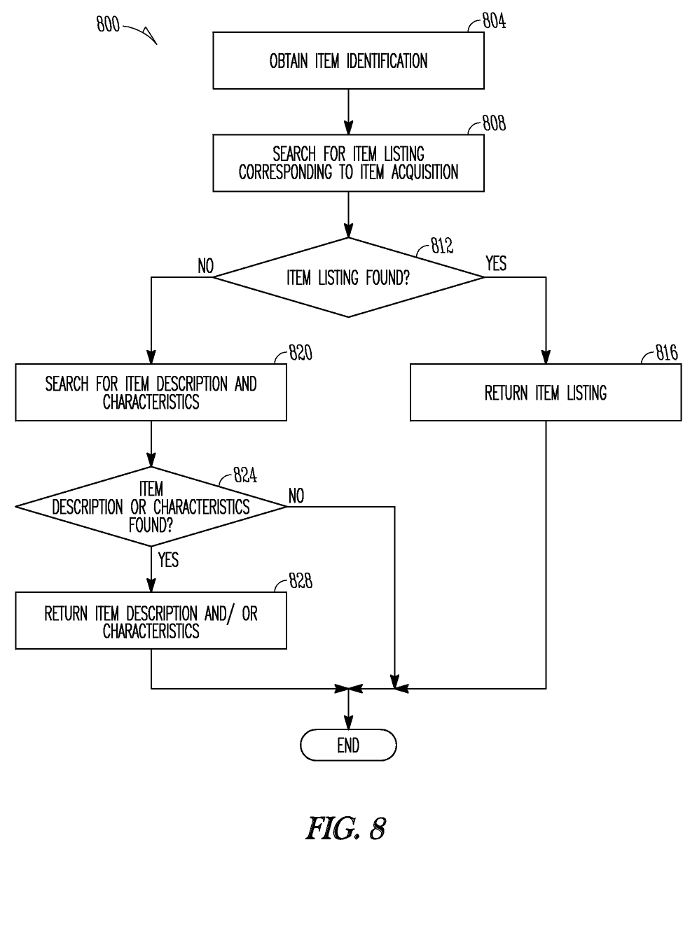

FIG. 8 is a flowchart for an example method for recommending a listing for an item, in accordance with an example embodiment. In one example embodiment, one or more of the operations of the item listing method 800 may be performed by the item listing processing module 410.

An identification of an item may be obtained (operation 804). For example, an identification of an item that a consumer has selected to list may be obtained from the user device 104-1. A search for an item listing corresponding to the item may be requested (operation 808). For example, the item listing and identification processing system 130 may be requested to search for and provide the item listing corresponding to the original acquisition of the item by the user, or an item listing of an identical, similar, or equivalent item. A test may be performed to determine if an item listing was found (operation 812). If an item listing was found, the item listing may be returned (operation 816) and the method may end; otherwise, a search for a list of descriptions and/or characteristics of the identified item may be performed (operation 820). For example, the item listing and identification processing system 130 may be requested to search for and provide descriptions and/or characteristics of items identical to, similar to, and/or equivalent to the identified item. A test may be performed to determine if a description and/or characteristics of an item identical to, similar to, and/or equivalent to the identified item were found (operation 824). If a description and/or characteristics of an item identical to, similar to, and/or equivalent to the identified item are obtained, the description and/or characteristics may be returned (operation 828); otherwise, the method may end.

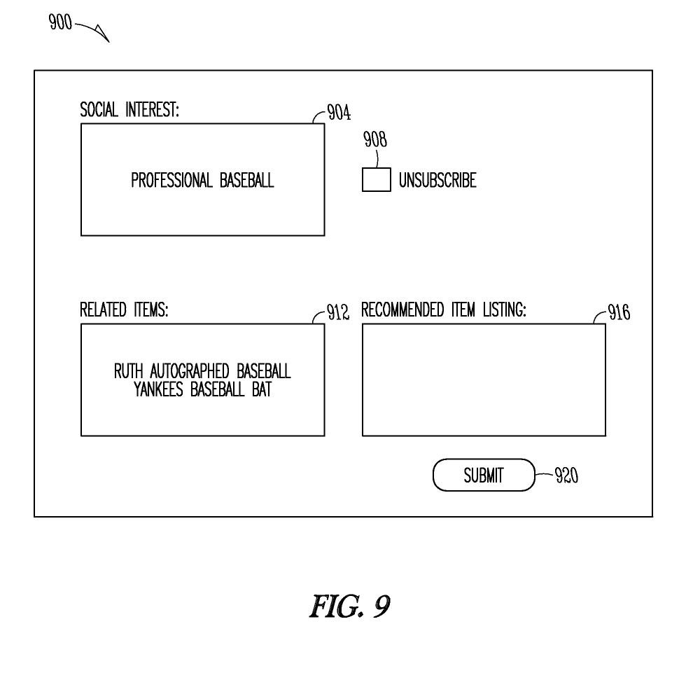

FIG. 9 is a representation of an example user interface 900 for listing an item on an electronic marketplace, in accordance with an example embodiment. A mobile device may provide the user interface 900, for example.

In one example embodiment, a user may unsubscribe to following a particular social interest by entering an identification of the social interest in the social interest identification field 904 and selecting the unsubscribe radio button 908. In response, a list of acquired items related to the social interest may be displayed in a related items list area 912. The user may select one or more of the items in the item list area 912 that the user would like to list for sale.

A recommended item listing for one of the selected items may be displayed in an item listing field 916. The user may modify the recommended listing in the item listing field 916. For example, the user may update a condition rating of the item and/or submit a recent picture of the item. The user may submit the modified item listing by selecting the submit item listing radio button 920.

Although certain examples are shown and described here, other variations exist and are within the scope of the invention. It will be appreciated by those of ordinary skill in the art that any arrangement, which is designed or arranged to achieve the same purpose, may be substituted for the specific embodiments shown. This application is intended to cover any adaptations or variations of the example embodiments of the invention described herein. It is intended that this invention be limited only by the claims, and the full scope of equivalents thereof.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network 115 (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

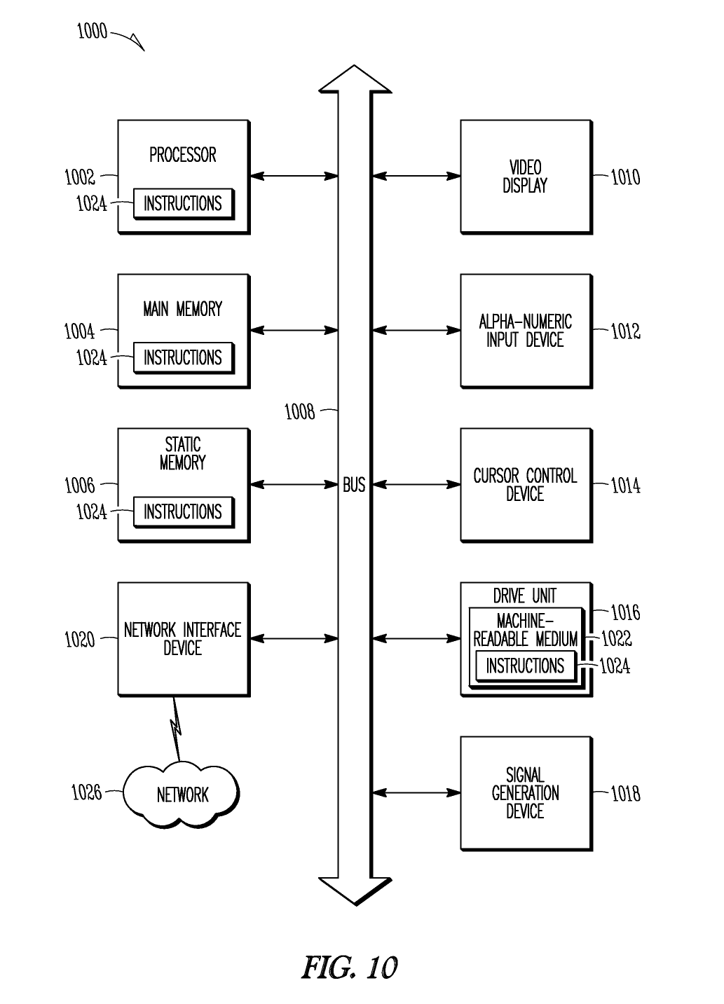

FIG. 10 is a block diagram of a machine within which instructions may be executed for causing the machine to perform any one or more of the methodologies discussed herein. In one example embodiment, the machine may be the user device 104. In one example embodiment, the machine may be the seller processing system 108 and/or group transaction processing system 110. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU), or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 100 also includes an alphanumeric input device 1012 (e.g., a keyboard), a user interface (UI) navigation device 1014 (e.g., a mouse), a disk drive unit 1016, a signal generation device 1018 (e.g., a speaker), and a network interface device 1020.

### Machine-Readable Medium

The drive unit 1016 includes a machine-readable medium 1022 on which is stored one or more sets of instructions and data structures (e.g., software) 1024 embodying or utilized by any one or more of the methodologies or functions described herein. The instructions 1024 may also reside, completely or at least partially, within the main memory 1004 and/or within the processor 1002 during execution thereof by the computer system 1000, with the main memory 1004 and the processor 1002 also constituting machine-readable media. Instructions 1024 may also reside within the static memory 1006.

While the machine-readable medium 1022 is shown in an example embodiment to be a single medium, the term “machine-readable medium” may include a single medium or multiple media (e.g., a centralized or distributed database, and/or associated caches and servers) that store the one or more instructions 1024 or data structures. The term “machine-readable medium” shall also be taken to include any tangible medium that is capable of storing, encoding or carrying instructions 1024 for execution by the machine and that cause the machine to perform any one or more of the methodologies of the present invention, or that is capable of storing, encoding or carrying data structures utilized by or associated with such instructions 1024. The term “machine-readable medium” shall accordingly be taken to include, but not be limited to, solid-state memories, and optical and magnetic media. Specific examples of machine-readable media 1022 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1024 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus for listing an item in an electronic commerce marketplace, the apparatus comprising:
a processor; and
memory to store instructions that, when executed by the processor, cause the processor to:
obtain data indicating that a user is no longer interested in a social interest;
compare the obtained data with item data for one or more items acquired by the user to identify item data that relates to the social interest; and
store the identified item data to generate a list of identified items.

2. The apparatus of claim 1, wherein the comparison is based on a transaction history of the user that comprises data related to one or more items acquired by the user and a list of related social interests for each of one or more of the acquired items.

3. The apparatus of claim 1, further comprising instructions that, when executed by the processor, cause the processor to:
obtain one or more selections from the list of identified items from a user.

4. The apparatus of claim 3, further comprising instructions that, when executed by the processor, cause the processor to:
provide a recommended item listing for each of one or more of the selected items.

5. The apparatus of claim 4, wherein the recommended listing is based on an item listing corresponding to an acquisition of the item.

6. The apparatus of claim 4, wherein the recommended listing is based on one or more of a description of an identical, equivalent, or similar item and a characteristic of an identical, equivalent, or similar item.

7. The apparatus of claim 4, further comprising instructions that, when executed by the processor, cause the processor to:
obtain a modified item listing from the user.

8. The apparatus of claim 7, wherein the modified item listing is based on the recommended item listing.

9. The apparatus of claim 7, wherein the modified item listing comprises one or more of a recent condition of the item and a recent picture of the item.

10. The apparatus of claim 9, further comprising instructions that, when executed by the processor, cause the processor to:
request one or more of the recent condition of the item and the recent picture of the item.

11. The apparatus of claim 1, further comprising instructions that, when executed by the processor, cause the processor to:
compare each of one or more social interests identified as being associated with an item to the social interest of the obtained data.

12. The apparatus of claim 1, further comprising instructions that, when executed by the processor, cause the processor to:
parse one or more of a name of an item, a description of an item, and a characteristic of an item;
determine one or more social interests associated with the item; and
compare each of the one or more determined social interests to the social interest of the obtained data.

13. A method for listing an item in an electronic commerce marketplace, the method comprising:
obtaining data indicating that a user is no longer interested in a social interest;
comparing the obtained data with item data for one or more items acquired by the user to identify item data that relates to the social interest; and
storing the identified item data to generate a list of identified items.

14. The method of claim 1, wherein the comparison is based on a transaction history of the user that comprises data related to one or more items acquired by the user and a list of related social interests for each of one or more of the acquired items.

15. The method of claim 1, further comprising obtaining one or more selections from the list of identified items from a user.

16. The method of claim 15, further comprising providing a recommended item listing for each of one or more of the selected items.

17. The method of claim 16, further comprising obtaining a modified item listing from the user comprising one or more of a recent condition of the item and a recent picture of the item.

18. The method of claim 1, further comprising comparing each of one or more social interests identified as being associated with an item to the social interest of the obtained data.

19. The method of claim 1, further comprising:
parsing one or more of a name of an item, a description of an item, and a characteristic of an item;
determining one or more social interests associated with the item; and
comparing each of the one or more determined social interests to the social interest of the obtained data.

20. A non-transitory computer-readable medium embodying instructions that, when executed by a processor, perform operations comprising:
obtaining data indicating that a user is no longer interested in a social interest;
comparing the obtained data with item data for one or more items acquired by the user to identify item data that relates to the social interest; and
storing the identified item data to generate a list of identified items.
